(19) United States
(12) Patent Application Publication
(10) Pub. No.: US 2019/0354594 A1
(43) Pub. Date: Nov. 21, 2019

(54) BUILDING AND DEPLOYING PERSONA-BASED LANGUAGE GENERATION MODELS

(71) Applicant: Microsoft Technology Licensing, LLC, Redmond, WA (US)

(72) Inventors: Jonathan Burgess Foster, Seattle, WA (US); Tulasi Menon, Hyderabad (IN); William Brennan Dolan, Kirkland, WA (US); Radhakrishnan Srikanth, Hyderabad (IN); Sai Tulasi Neppali, Hyderabad (IN); Michel Galley, Seattle, WA (US); Christopher John Brockett, Bellevue, WA (US); Parag Agrawal, Hyderabad (IN); Rohan Kulkarni, Hyderabad (IN); Ronald Kevin Owens, Seattle, WA (US); Deborah Briana Harrison, Seattle, WA (US)

(21) Appl. No.: 15/984,356

(22) Filed: May 20, 2018

(51) Int. Cl. G06F 17/28; G06F 17/30; G06F 17/27; H04L 12/58; G06N 3/02

(52) U.S. Cl. CPC G06F 17/2881; G06F 17/30654; G06N 3/02; H04L 51/02; G06F 17/2785

(57) ABSTRACT

Conversations can be generated automatically based on any given persona. The conversations can be produced by a language generation model that automatically generates persona-based language in response to a message, wherein a persona identifies a type of person with role specific characteristics. After a language generation model is acquired, for example by identifying a predefined model or generating a new model, the language generation model can be provisioned for use by a conversational agent, such as a chatbot, to enhance the functionality of the conversational agent.

### BACKGROUND

A conversational agent, such as a chatbot, is a computer system that can be interacted with in a conversational manner. More specifically, a conversational agent seeks to mimic communication of a real person and provide a human-machine interface that operates based on human conversation. In one instance, a conversational agent can be utilized in conjunction with text messaging applications, such that users can invoke and communicate with a conversational agent by way of text message. Other modalities are also available including spoken language in spoken language conversational agents. Conversational agents can be used in various domains and provide a broad range of applications including responding to customer requests regarding products and services, and providing customer service, technical support, education, and personal assistance.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to building and deploying persona-based language generation models. A persona-based language generation model can be employed to enhance conversational capabilities of a conversational agent. A persona can be identified from a set of predefined personas or custom generated, wherein a persona comprises a type of person with role specific conversational characteristics. A language generation model can be created that corresponds to a persona such that generated language is consistent with the persona. The persona-based language generation model can be deployed with conversational agents for use in responding to input messages. For example, the persona-based language generation model can be employed to fill gaps of conversational agents including, but not limited to, small talk or casual conversation.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 is a schematic block diagram of a conversation generation system.

FIG. 2 is a schematic block diagram of an exemplary generator component.

FIG. 3 is a schematic block diagram of an extended conversational agent.

FIG. 4 is a flow chart diagram of a method of provisioning conversation generation for a persona.

FIG. 5 is a flow chart diagram of a method of message processing.

FIG. 6 is a flow chart diagram of a message processing method.

FIG. 7 is a flow chart diagram of a method of generating a language generation model based on persona configuration settings.

FIG. 8 is a flow chart diagram of a method of generating a language generation model based on dialog data.

FIG. 9 is a schematic block diagram illustrating a suitable operating environment for aspects of the subject disclosure.

### DETAILED DESCRIPTION

A gap exists in conversational capabilities of conversational agents, especially around small talk or, in other words, chitchat or casual conversation. Conventionally, responses to messages are scripted or predetermined, such that when keywords are detected a corresponding scripted response is returned. For example, a message “Thank you” will elicit the response “You're welcome.” Typically, there are a hundred or more prepackaged message response pairs. The task of crafting scripted responses, however, is very time consuming and still solves only a small part of the problem, since it is unlikely that scripted responses will be created for all possible messages. Accordingly, the inherent promise of being truly conversational is not being met and is frustrating to users when conversational agents are not able to understand and respond to typical human conversations.

Details below generally pertain to building and deploying persona-based language generation models. A machine-learning language generation model can be created that automatically generates language associated with small talk in response to messages. The language generation model can also produce persona-based language, wherein persona identifies a type of person with role specific communication characteristics and can be predefined or custom crafted. The language generation model can be provisioned for use by a conversational agent, such as a chatbot, for example by way of a service the conversational agent can employ. The conversational agent can utilize the language generation model in a variety of ways. For example, a conversational agent can utilize the language generation model to generate a response as a fallback in cases where there is no predetermined response. Additionally, or alternatively, the language generation model can be integrated with task-oriented messages to enable the responses to be similar to that of a real person or particular type of person. Conversation can be generated that is human like and relatable with respect to a particular type of person, and therefore useful in responding to human conversation.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

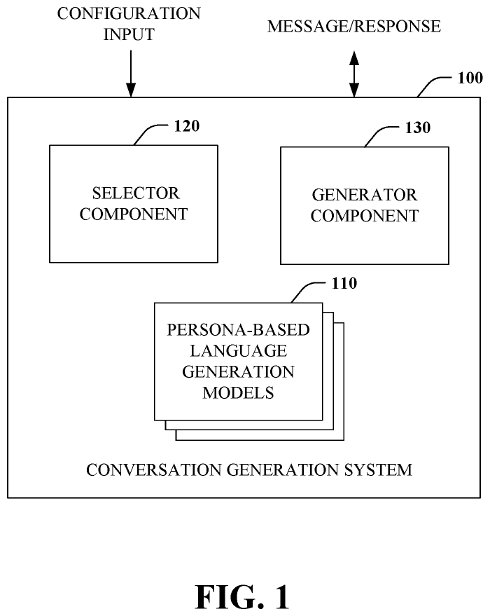

Referring initially to FIG. 1, a conversation generation system 100 is illustrated. The conversation generation system 100 can receive configuration input regarding at least a persona, which identifies a type of person with role specific communication characteristics or, simply, a particular kind of person as understood by how the person communicates (e.g., helpful, friendly, professional, funny, cool, child, hybrid . . . ). The conversation system 100 can also receive a message or utterance, such as a query, as input and output a response in language that matches any given persona. Included in the conversation generation system 100 are one or more persona-based language generation models 110, selector component 120, and generator component 130.

The persona-based language generation models 110 are machine learning models. In accordance with one implementation, a deep neural network model can be employed, but the subject disclosure is not limited thereto. Further, the deep neural network model can be a recurrent neural network that maps sequences to sequences in accordance with long short-term memory (LSTM). In one instance, models used for language translation can be similarly employed to produce a response to a message. For example, an input of “How are you?” can result in an output of “I am well,” as opposed to a translation of the input question to another language. Moreover, persona identification, or persona vectors (e.g., speaker/user identifiers matched to persona), can be embedded in the model, such as a hidden layer of a neural network, to enable clustering of people and their utterances around communication traits. In another instance, persona can be incorporated into the model through multitask training whereby a model characterized by a persona is trained jointly with a background model of conversational language. These and other related techniques can be utilized alone or in combination with each other. For example, the persona-based language generation model can be trained using a feedback technique such as an adversarial generative network. The persona-based language generation models 110 can be trained and evaluated with vast quantities of real human conversations, for example from social media sites or television scripts.

The selector component 120 is configured to enable selection of predefined or prepackaged personas. The selector component 120 can expose an interface, for example, that renders available personas associated with language generation and receives a selection of a persona. Predefined personas can be personas that are likely to be popular or common. For example, predefined personas can include, but are not limited to, helpful and friendly for support, fun and cool targeting teens or more casual audiences, formal for trusted guidance (for example, for recommendations and directions), smart and informed targeting education or information seeking audiences, and child oriented for young audiences. Since models associated with these personas are already built, the models can be immediately available for use by conversational agents (e.g., chatbot, personal assistant, game character, conversation-enabled physical robot . . . ) after selection, for example by way of an internet-based service interface or downloading the model. The selected persona can thus be infused into responses.

The generator component 130 is configured to enable specification of customized personas. It can be critical that a conversation agent, such as a chatbot, accurately reflect brand, values, and particular context of a business. Similarly, characters in a game may have quite distinct personas in accordance with different roles. Thus, as opposed to selecting a predefined persona, a customized persona can be constructed.

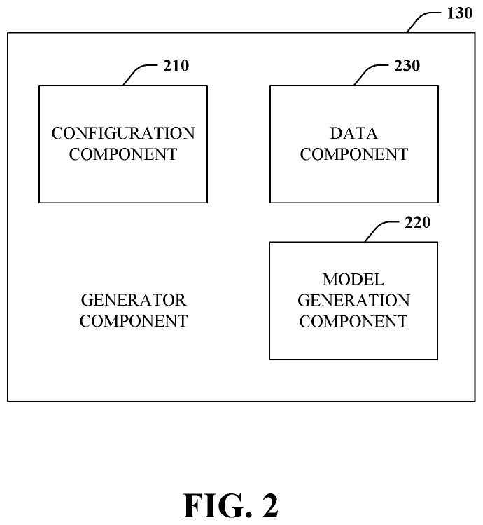

Turning attention to FIG. 2, an exemplary generator component 130 is depicted in further detail including configuration component 210, model generation component 220, and data component 230. The configuration component 210 supplies an interface that allows a user to specify persona configuration settings or parameters identifying desirable and/or undesirable traits in a persona. As an example, a set of buttons, dials, and sliders can be rendered in a graphical interface to allow selection of a particular characteristic and level of characteristic such as friendliness, chattiness/terseness, humor, and vocabulary complexity. For instance, it may not be desirable for a conversational agent in a word processing application to be making chatty comments regarding how a document looks, but where one is vacation planning friendly chat may be more acceptable. Based on the configuration settings input, the model generation component 220 generates a language generation model targeting a particular persona. In accordance with one implementation, crowd sourcing or the like could be utilized to identify a speaker or type of speaker that meets the configuration settings for instance through ratings of utterances on a scale regarding chattiness/terseness, humor, and vocabulary complexity.

The data component 230 can accept and analyze input conversational data. For instance, customer service logs, social network communications, or written documents can be input to the conversation generation system 100 through the data component 230. From this data a persona can be determined. In one instance, text can be analyzed to determine statistics regarding language including n-gram usage such as what words are used, what sequence of two words are used, what sequence of three words are used, etc. Based on the analysis a persona can be determined. The model generation component 220 can generate a language generation model specific to the persona determined from the data such that responses emulate the determined persona. For example, if uploaded conversational data is friendly and helpful, responses produced by a language generation model will also be consistent with the persona, namely friendly and helpful.

The model generation component 220 can utilize a variety of techniques to produce persona-based language generation models based on configuration settings or representative data input. In one scenario, the model generation component 220 can locate a particular person whose utterances match a specified configuration such that responses sound like this person. However, a single person is not likely to have contributed vast amounts of data for used by the model to produce fluent responses. Accordingly, the particular person can be used as a centroid of a set of people with similar responses. Thus, a model is generated with responses that sound like the particular user or others who pattern like the user in the data. Similarly, with respect to input conversational data, computed language statistics can be compared and matched with statistics regarding known utterances to identify a particular person or set of people that can be utilized as a centroid from which a set of other people who pattern like the set of people in the data can be located for use in generating responses.

Returning to FIG. 1, although selection of a predefined persona by way of selector component 120 and generation of a custom persona by way of generator component 120 is seemingly indicated as a binary choice, this need not be the case. In fact, a predefined persona can be selected as a base persona and used as a springboard for further customization. Configuration settings of a predefined persona can be presented and subject to modification to specify a custom persona and generate a related language generation model that mimics the persona. For instance, a graphical user interface can be employed that allows the configuration settings of a predefined persona to be changed by selection and manipulation of various buttons, dials, and sliders related to persona characteristics such as friendliness, humor, and vocabulary complexity (e.g., adult vs. child . . . ), among others. In one instance, such tuning can be performed by creating and refining a data set based on a particular characteristic level. The data set for each level of a persona characteristic can be changed to correspond to the level. For example, a model with a default friendliness level of five is associated with a corresponding data set, and fine tuning of the friendliness to a level of eight results in use of a different data set corresponding to level eight. This can be enabled by way of labels on conversations rating friendliness a scale from one to ten, for instance specified manually (e.g. crowd sourcing) or automatically by way of a classifier.

The persona-based language generation models 110 including predefined and customized models, or functionality associated with the models, can be further configured with respect to which types of messages to respond to and which messages to ignore. Stated differently, selections can be made as to what kind of broad intents are responded to by generating responses using the persona-based language generation model 110. Intent is the purpose or goal of a message that expresses what a user is asking for, which can be embodied as a category of information. Examples of intent include greetings, generic expressions, opinions, compliments, criticisms, user sentiment, reminders, and weather check, among other things. The persona-based language generation models can encode whether or not to respond to certain intents. In this manner, persona is further defined in terms of intents for which responses are generated. For instance, a professional persona can be defined to respond to intents such as greetings, compliments, feedback, and user sentiment, but not opinions. By contrast, a friendly persona can also be defined to respond to opinions. Accordingly, there can be a number of intents identified as acceptable and unacceptable for personas which are predefined or customized.

In accordance with one embodiment, the persona-based generation models 110 can also take context into account when generating responses. As an example, consider a context associated with planning or booking a vacation. The generated response will not be one liners, random jokes, or the like. Rather, the response can be at least tangentially related to the context. In the example, the context is vacation planning and responses can be related thereto. Context can be extracted from the message itself or provided by a conversational agent with a forwarded message.

In accordance with another aspect, persona-based language generation models 110 can be customized for particular domains. For example, a domain can be selected from one of finance, retail, medical, or sports, among others. A language generation model tuned for the selected domain can then be utilized. If no provided domain fits, a generic language generation model can be utilized.

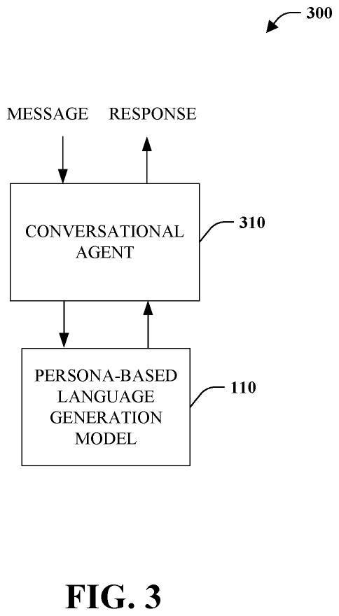

FIG. 3 shows a diagram of an extended conversational agent system 300. The system 300 includes conversational agent 310 and a persona-based language generation model 110. The conversational agent 310 is configured to receive messages and output responses to the received messages. Further, the conversational agent 310 provides a means to mimic communication of a real person and provide a human-machine interface that operates based on human conversation. The conversational agent 310 can include typical components including input recognizer (e.g., speech, handwriting . . . ), text analyzer (e.g., part of speech identification, syntactic/semantic parser . . . ), management component for managing state and history of dialog, and contacting one or more components for processing of tasks, and an output generator for rendering a response (e.g., text-to-speech engine, robot, avatar . . . ). Furthermore, conversational agent 310 can correspond to a chatbot, agent, personal assistant, game character, or conversation-enabled physical robot, among other things. Here, the conversational agent 310 is extended further to include access to the persona-based language generation model 110. In accordance with one embodiment, the model is able to generate fluent small talk, or chitchat, in accordance with a particular persona in response to a message, wherein small talk corresponds to social conversation regarding trivial or uncontroversial matters.

The persona-based language generation model 110 can, in one instance, be utilized to fill conversational gaps. Gaps in conversational capability can exist with respect to small talk and frustrate users when the conversational agent 310 is not able to understand and respond to typical human conversations. The persona-based language generation model 110 can generate responses for any message, even messages it has not seen or responded to before, and thus can be utilized to fill a conversational gap. In other words, the conversational agent can fallback on the persona-based language generation component 110 when it has nothing to say in response to a message. This may be the case when responses to small talk are scripted, but there is no scripted response to a received message. The persona-based language generation model 110 can thus enhance the conversational agent 310 by filling conversational gaps.

In one embodiment, the conversational agent 110 can segregate task processing and small talk or chitchat. The conversational agent 110 can alternate between the two but they are not intermingled. In another embodiment, tasks and small talk can be integrated. Stated differently, a unified model approach can be supported in which both chatty behavior and directed behavior are employed. In accordance with one implementation, this can be accomplished by embedding slots in a persona-based language generation model for function calls. By way of example consider a message “What's the weather today? I hope there's no rain.” The response can be templatic and include slots for retrieval and insertion of pertinent weather information. Thus, the response can be “Sorry, there is a high chance of rain, but not too cold at 50 degrees. Don't forget your umbrella!” In this example, the slots that are filled correspond to “rain” and “50 degrees.” This response is dynamically generated based on inputs received from elsewhere (e.g., application programming interface calls) based on context. As another example, consider the message or query “How far is Seattle from Hyderabad anyway?” The small talk or chatty response can be “Pretty far. It's 7,770 miles away.” Here, the slot that is being filled by external function call is the distance “7,770.” Alternatively, task-oriented responses can be build into language generation model such that templates and slot filling need not be employed.

Further, responses to messages can trigger an action alone or in combination with a language response. Consider for as examples a message that specifies that movie tickets should be purchased, or lights should be turned on. The response can simply trigger the corresponding action by invoking an application programming interface associated with the action, for example. A friendly informal language response could also be generated such as “It looks brighter in here now that I turned on the lights.” In other words, are response can correspond to a language and/or action.

Returning briefly to FIG. 1, in one instance the conversation generation system 100 can be incorporated into a conversational agent development system (not shown). The conversational agent development system can support building, connecting, and deploying conversational agents. The conversation generation system 110 can be added to enable configuration and creation of a persona-based language generation model or selecting a predefined persona and associated language generation model. The integration of the conversation generation system 100 with conversational agent development can enable predefined or custom language generation models to be highly compatible and easy to use.

In one instance the persona-based language generation models can be built and deployed by way of an internet-based service. For example, a web portal can be provided that allows a user to select a predefined or build a custom persona-based language generation model that can be exposed as a service or made available for download. Consider, for example, a movie theater company that desires to sell movie tickets through a conversational agent. A web portal can be utilized to upload data and/or specific configuration settings. A persona-based language generation model can be generated based on the data and/or configuration settings and made available for use by the movie theater. The result is a persona-based conversational agent is provided by the movie theater that enables tickets to be purchased by way of a friendly or casual conversation, for example.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with a push and/or pull model. The components may also interact with one or more other components not specifically described herein for the sake of brevity, but known by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, such techniques can be employed in conjunction with generating responses to messages with a particular persona.

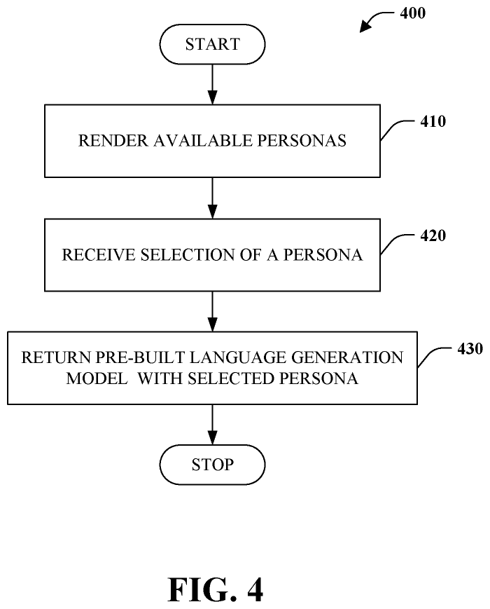

In view of the exemplary systems described above, methodologies that may be implemented in accordance with the disclosed subject matter will be better appreciated with reference to the flow charts of FIGS. 4-8. While for purposes of simplicity of explanation, the methodologies are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 4 illustrates a method 400 of provisioning conversation generation for a persona. At reference numeral 410, available personas are rendered or made accessible. A persona can correspond to a type of person with role specific communication characteristics. In other words, a persona is a particular kind of person as understood by how the person communicates (e.g., helpful, friendly, professional, funny, cool, child . . . ). At reference 420, a selection of a persona is received. For example, selection of a friendly or professional persona can be received, retrieved, or otherwise obtained or acquired. At reference numeral 420, a pre-built language generation model is returned with the selected persona. The model can correspond to the persona-based language generation model 110, which can be made accessible by way of an internet-based service (e.g., web service) or downloaded. In accordance with one embodiment, the pre-built model can be selected and made accessible in conjunction with a conversational agent framework, which is a type of development environment that supports building, connecting, and deploying conversational agents. Further, after the pre-built model is made available it can become immediately available for use in extending a conversational agent such as a chatbot, agent, personal assistant, game character, or communication-enabled robot.

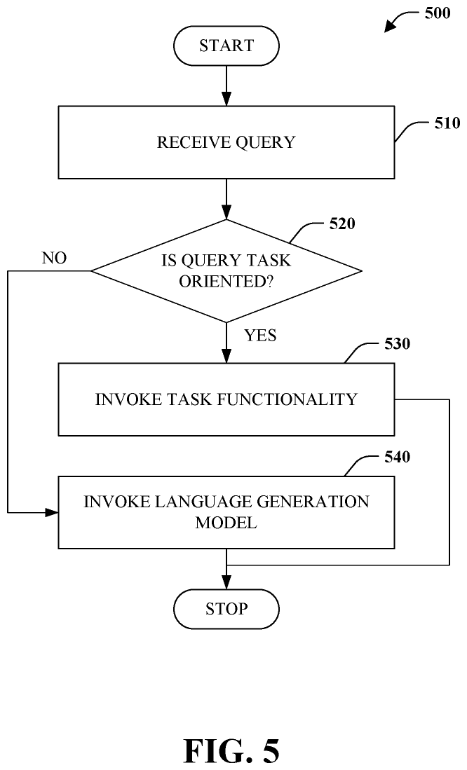

FIG. 5 is a flow chart diagram that depicts a method 500 of message processing. At reference numeral 510, a message is received, wherein the message is a query. At 520, a decision is made as to whether or not the query is task oriented or not. A task-oriented query seeks to accomplish a task such as book a vacation, order a product, or receive instructions, among other things. A more concrete example of a task-oriented query is “Can you book me a plane ticket to Seattle?” If the query is task oriented (“YES”), the method continues at reference numeral 530. At 530, task functionality is invoked to enable conversation to be directed toward accomplishing a particular task. Subsequently, the method 500 terminates. If, at 520, a query is not task oriented (“NO”), the method continues at reference numeral 540. A query that is not task oriented is one that does not seek to accomplish a task but rather can be small talk or chitchat about things that are trivial or uncontroversial, for example “How are you?” or “Where do you live?” At 540, a language generation model is invoked. Here, the invoked model can be one of the persona-based language generation models 110, which can automatically generate a response to the query in language that corresponds to a persona (e.g., friendly, professional, funny, cool . . . ).

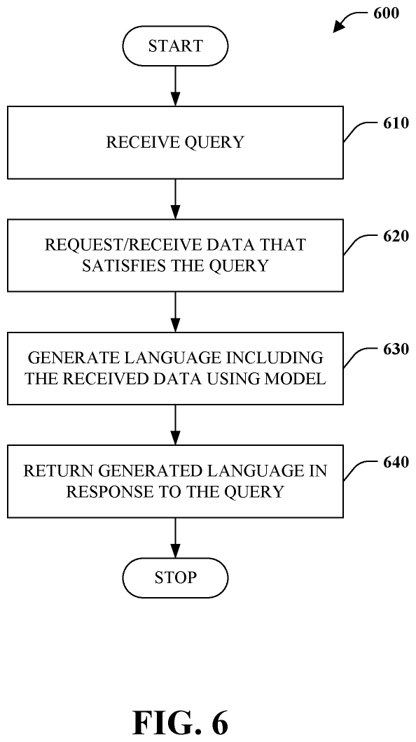

FIG. 6 illustrates another method of processing a message 600. At reference numeral 610, a message is received, wherein the message is a query. For example, the query can be “Is it going to be sunny today?” At numeral 620, data that is required to satisfy the query is requested and received. For example, weather data can be requested and received by interaction with a weather application programming interface. At reference numeral 630, language is generated including the received data using a persona-based language generation model 110. In one implementation, functionality can be invoked involving slot filling to parameterize language generation. Continuing with the ongoing example, the generated response can be “Sony, it will be cloudy today with a high chance of showers. Don't forget your umbrella!” In this case weather data, namely cloudy and chance of showers are integrated into a response that satisfies the query and is casual and friendly in nature. In addition to receiving data from an external source, it should be appreciated that a response can trigger, or include, an action directed toward completion of a message that is task-based. For example, a message that requests that lights be turned on can be responded to by turning on the lights. At reference numeral 640, the generated response to the query is returned.

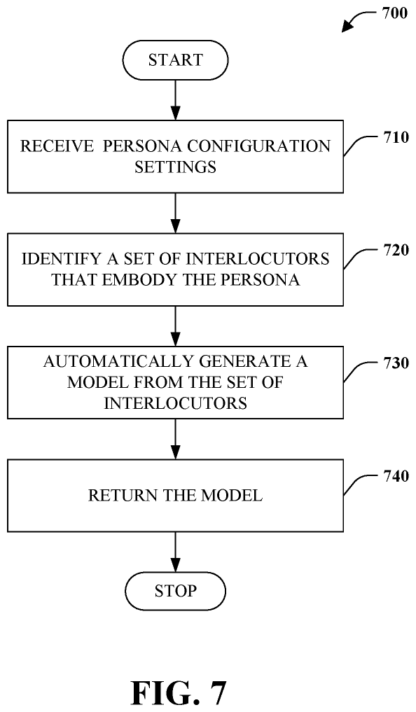

FIG. 7 is a flow chart of a method 700 of generating a language generation model based on configuration settings. At reference numeral 710, persona configuration settings are received. For example, a number of characteristics, such as friendliness and terseness, and their levels can be specified with respect to various buttons, dials, and sliders in a graphical user interface provided to receive such configuration settings. Further, a set of one or more intents (e.g., greetings, compliments, feedback, user sentiment, opinion . . . ) can be identified that specify categories of messages that should be responded to and/or ignored. At numeral 720, an interlocutor or set of interlocutors can be identified that employ the persona specified by the configuration settings. In other words, the identified interlocutor or set thereof converse in a manner consistent with a persona specified. An interlocutor can be identified by a user or speaker identifier, which can be referred to as a persona identifier once a user identifier is matched to a persona. At reference 730, a persona-based language generation model is automatically generated based on the identified interlocutors. Additionally, the persona-based language generation model can be created to include action paths based on intent of a message, such as whether or not to respond to a specific intent. At numeral 740, the generated model is returned, for example for use by a conversational agent such as a chatbot, game character or conversation-enabled physical robot. The model enables responses to be generated that mimic the style and tone of the one or more interlocutors representative of the persona configuration.

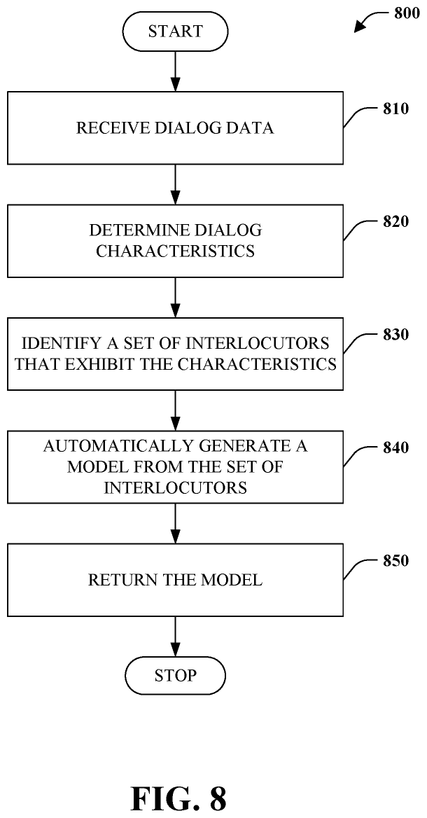

FIG. 8 depicts a method 800 of generating a language generation model from input data. At reference numeral 810, dialog data is received. For example, dialog data documenting real human conversations or automated response systems can be received. At reference 820, dialog data characteristics are determined. For example, statistics can be generated associated with n-grams such as what words are used, what sequence of two words are used, what sequence of three words are used, etc. At reference numeral 830, a set of interlocutors that exhibit the characteristics are identified. For example, communications for various users can also have statistics generated that are associated with n-grams. Identification then comprises matching similar interlocutors. At numeral 840, a persona-based language generation model 110 is generated automatically from the communications associated with the set of identified interlocutors. At reference numeral 850, the generated model is returned, for example for use by a conversational agent to extend functionality associated with small talk or casual conversation. In one instance, the language generation model can fill a gap in conversational capabilities associated with scripted responses.

Persona-based language generation models and automatic language generation based thereon have been a focus herein. However, this is not meant as a limitation. In fact, persona can be infused in other ways including customized editable-scripted responses and persona-based data from a conversation agent developer.

There are many different ways to customize a model for persona. As described above, one way is by using a persona identifier. More specifically, the closest speaker identifier from training data can be set as the persona identifier. In this case, a model does not have to be retrained. However, retraining can also be utilized to customize a model for persona. For example, a decoder of a model can be retrained to make it consistent with a desired persona. In another instance, words can be removed, or new words added by retraining a model. By way of example, vocabulary can be substantially limited for a child-oriented persona.

The persona techniques disclosed herein have broad application across various domains. Conversational agent, as used herein, is meant to refer broadly to conversation-based human-machine interfaces in the various domains, wherein the machine seeks to mimic communication of a real person in response to natural language messages or utterances. In one instance, the conversational agent can correspond to a chatbot or agent. Alternatively, conversational agent can encompass game characters, personal assistants, virtual environments, and conversational-enabled physical robots, among others. With respect to games, for example, voices of characters in a game with different roles can be generated such that they have distinct personas.

Aspects of the subject disclosure pertain to the technical problems associated with natural language processing in the context of machine-implemented conversation (e.g., chatbot, game character, physical robot, personal assistant . . . ) that receive natural language messages from users and seek to return human-like natural language responses to the messages. More specifically, there exists a gap in the conversational capabilities of conversation agents, especially around small talk, or chitchat. The aforementioned gap is filled by employing machine learning to develop a language generation model that given a message generates a corresponding response. Further, responses can be tailored to a particular persona by embedding speaker/user identifiers or persona identifiers (e.g., speaker/user identifiers matched to persona) within the model.

The subject disclosure supports various products and processes that perform, or are configured to perform, various actions regarding automatic conversation generation. What follows are one or more exemplary systems and methods.

A system comprises a processor coupled to a memory, the processor configured to execute computer-executable instructions stored in the memory that when executed cause the processor to perform the following actions: acquiring a language generation model that automatically generates persona-based language in response to a message, wherein a persona identifies a type of person with role specific communication characteristics; and provisioning the language generation model for use with a conversational agent. Further, the language generation model can automatically generate small talk in response to the message, wherein small talk comprises conversation about unimportant or uncontroversial matters in a social setting, and small talk is relevant to context of the message. In one instance, responses to a predefined subset of messages are scripted. Acquiring the language generation model further comprises identifying a prebuilt language generation model that matches a persona or generating the language generation model based on the persona. In one instance, the persona can be determined from uploaded conversational data. In another instance, the persona can be determined from a set of configuration settings. Further, the language generation model can respond to a task-directed, or goal-directed, message with at least one of language or an action directed toward performing the task. Furthermore, the language generation model can be a sequence-to-sequence neural network with an embedded persona identifier uniquely mapped to interlocutors.

A method comprises employing at least one processor configured to execute computer-executable instructions stored in a memory that when executed cause the at least one processor to perform the following acts: acquiring a language generation model that automatically generates persona-based language in response to a message, wherein a persona identifies a type of person with role specific communication characteristics; and provisioning the language generation model to a conversational agent for responding to messages received by the conversational agent. In one instance, the language generation can automatically generate small talk in response to the message. Acquiring the language generation model further comprises identifying a prebuilt language generation model that matches a persona or generating the language generation model based on the persona. Determining the persona can accomplished from uploaded conversational data or a set of configuration settings.

A system comprises means for acquiring a language generation model that automatically generates persona-based language as a response to a message, wherein a persona identifies a type of person with role specific communication characteristics; and means for distributing the language generation model to a conversational agent for responding to messages received by the conversational agent. The language generation model automatically generates small talk as the response to the message, wherein small talk comprises social conversation about unimportant or uncontroversial matters. Further, acquiring the language generation model comprises identifying a prebuilt language generation model that matches a persona or generating the language generation model based on the persona. Furthermore, the language generation model can be a sequence-to-sequence neural network with an embedded persona identifier uniquely mapped to interlocutors.

The term “persona” as used herein is intended to refer to a type of person with role specific communication characteristics. More specifically, persona refers to a character adopted by a person that reflects a role the person is playing (e.g., customer service provider, teacher, adviser . . . ). The character comprises a collection of one or more qualities (e.g., helpful, friendly, professional, funny, cool, child, hybrid . . . ). Personality, by contrast, refers to a distinctive combination of qualities of a specific person, without regard to role.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “'A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

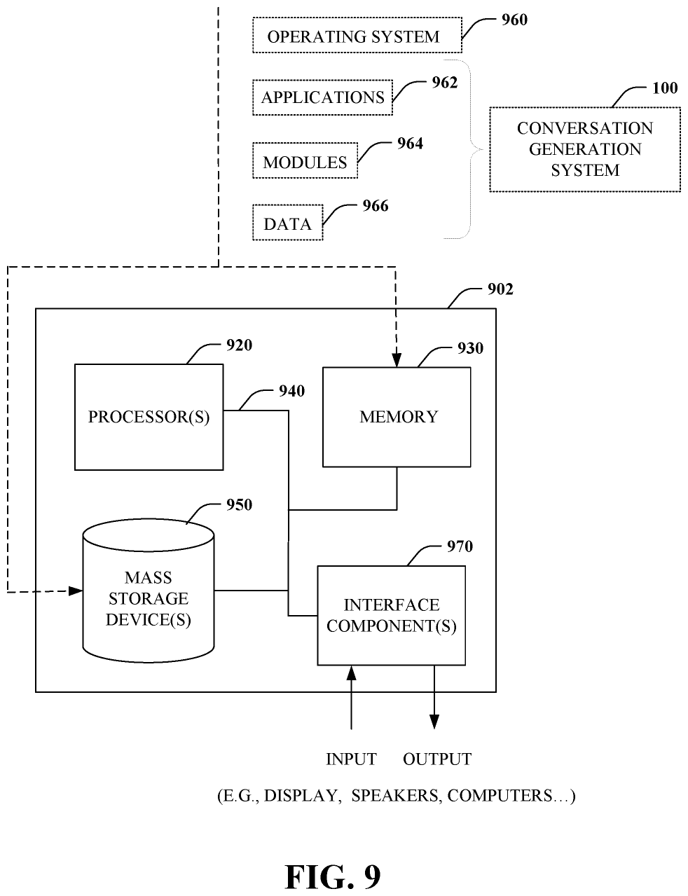

In order to provide a context for the disclosed subject matter, FIG. 9 as well as the following discussion are intended to provide a brief, general description of a suitable environment in which various aspects of the disclosed subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example general-purpose computer or computing device 902 (e.g., desktop, laptop, tablet, watch, server, hand-held, programmable consumer or industrial electronics, set-top box, game system, compute node . . . ). The computer 902 includes one or more processor(s) 920, memory 930, system bus 940, mass storage device(s) 950, and one or more interface components 970. The system bus 940 communicatively couples at least the above system constituents. However, it is to be appreciated that in its simplest form the computer 902 can include one or more processors 920 coupled to memory 930 that execute various computer executable actions, instructions, and/or components stored in memory 930.

The processor(s) 920 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 920 can be a graphics processor.

The computer 902 can include or otherwise interact with a variety of computer-readable media to facilitate control of the computer 902 to implement one or more aspects of the disclosed subject matter. The computer-readable media can be any available media that can be accessed by the computer 902 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 902. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 930 and mass storage device(s) 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 902, such as during start-up, can be stored in nonvolatile memory, while volatile memory can act as external cache memory to facilitate processing by the processor(s) 920, among other things.

Mass storage device(s) 950 includes removable/non-removable, volatile/non-volatile computer storage media for storage of large amounts of data relative to the memory 930. For example, mass storage device(s) 950 includes, but is not limited to, one or more devices such as a magnetic or optical disk drive, floppy disk drive, flash memory, solid-state drive, or memory stick.

Memory 930 and mass storage device(s) 950 can include, or have stored therein, operating system 960, one or more applications 962, one or more program modules 964, and data 966. The operating system 960 acts to control and allocate resources of the computer 902. Applications 962 include one or both of system and application software and can exploit management of resources by the operating system 960 through program modules 964 and data 966 stored in memory 930 and/or mass storage device(s) 950 to perform one or more actions. Accordingly, applications 962 can turn a general-purpose computer 902 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the conversation generation system 100, or portions thereof, can be, or form part, of an application 962, and include one or more modules 964 and data 966 stored in memory and/or mass storage device(s) 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the conversation generation system 100 and/or associated functionality can be embedded within hardware in a SOC architecture.

The computer 902 also includes one or more interface components 970 that are communicatively coupled to the system bus 940 and facilitate interaction with the computer 902. By way of example, the interface component 970 can be a port (e.g. serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 902, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., LCD, LED, plasma, organic light-emitting diode display (OLED) . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible.

Accordingly, the disclosed subject matter is intended to embrace all such alterations, modifications, and variations that fall within the spirit and scope of the appended claims.

What is claimed is:

1. A system, comprising:
a processor coupled to a memory, the processor configured to execute computer-executable instructions stored in the memory that when executed cause the processor to perform the following actions:
acquiring a language generation model that automatically generates persona-based language in response to a message, wherein a persona identifies a type of person with role specific communication characteristics; and
provisioning the language generation model for use with a conversational agent.

2. The system of claim 1, the language generation model automatically generates small talk in response to the message, wherein small talk comprises conversation about trivial or uncontroversial matters in a social setting.

3. The system of claim 2, the small talk is relevant to context of the message.

4. The system of claim 1, acquiring the language generation model further comprising identifying a prebuilt language generation model that matches a persona.

5. The system of claim 1, acquiring the language generation model further comprising generating the language generation model based on the persona.

6. The system of claim 5 further comprising determining the persona from uploaded conversational data.

7. The system of claim 5 further comprising determining the persona from a set of configuration settings.

8. The system of claim 1, the language generation model responses to a task-oriented message with at least one of language or an action directed toward performing the task.

9. The system of claim 1, the language generation model is a sequence-to-sequence neural network with an embedded persona identifier uniquely mapped to interlocutors.

10. A method, comprising:
employing at least one processor configured to execute computer-executable instructions stored in a memory that when executed cause the at least one processor to perform the following acts:
acquiring a language generation model that automatically generates persona-based language in response to a message, wherein a persona identifies a type of person with role specific communication characteristics; and
provisioning the language generation model to a conversational agent for responding to messages received by the conversational agent.

11. The method of claim 10, the language generation model automatically generates small talk in response to the message, wherein small talk comprises casual conversation.

12. The method of claim 10, acquiring the language generation model further comprising identifying a prebuilt language generation model that matches a persona.

13. The method of claim 10, acquiring the language generation model further comprising generating the language generation model based on the persona.

14. The method of claim 13 further comprising determining the persona from uploaded conversational data.

15. The method of claim 10 further comprising determining the persona from a set of configuration settings.

16. A system, comprising:
means for acquiring a language generation model that automatically generates persona-based language as a response to a message, wherein a persona identifies a type of person with role specific communication characteristics; and
means for distributing the language generation model to a conversational agent for responding to messages received by the conversational agent.

17. The system of claim 16, the language generation model automatically generates small talk as the response to the message, wherein small talk comprises social conversation about trivial or uncontroversial matters.

18. The system of claim 16, the means for acquiring the language generation model further comprising identifying a prebuilt language generation model that matches a persona.

19. The system of claim 16, the means for acquiring the language further comprising generating the language generation model based on the persona.

20. The system of claim 16, the language generation model is a sequence-to-sequence neural network with an embedded persona identifier uniquely mapped to interlocutors.
